(19) United States
(12) Patent Application Publication
(10) Pub. No.: US 2016/0353763 A1
(43) Pub. Date: Dec. 8, 2016

(54) Edible Candle Kit

(71) Applicant: Jean Savignard, Las Vegas, NV (US)

(72) Inventor: Jean Savignard, Las Vegas, NV (US)

(21) Appl. No.: 15/174,128

(22) Filed: Jun. 6, 2016

Related U.S. Application Data
(60) Provisional application No. 62/171,026, filed on Jun. 4, 2015.

(51) Int. Cl. A23G 3/18; F23D 3/16; F23D 3/18; A23G 3/50

(52) U.S. Cl. CPC A23G 3/18; A23G 3/50; F23D 3/16; F23D 3/18; A23V 2002/00

(57) ABSTRACT

An edible candle kit includes an emblematic mold, a multi-phase edible composition, a candle, and a candle holder; the multi-phase edible composition having a liquid state and a solid state. The multi-phase edible composition is melted into the liquid state, wherein the emblematic mold is used to shape and retain the multi-phase edible composition as the multi-phase edible composition is transformed into the solid state. The multi-phase edible composition being in the solid state is then removed from the emblematic mold and a candle holder is positioned onto the multi-phase edible composition. The candle is then positioned into a receiving volume of the candle holder, wherein the candle is retained on top of the multi-phase edible composition in an upright position.

The current application claims a priority to the U.S. Provisional Patent application Ser. No. 62/171,026 filed on Jun. 4, 2015.

### FIELD OF THE INVENTION

The present invention relates generally to candles. More specifically, the present invention is an edible candle kit that allows a user to build a custom candy candle.

### BACKGROUND OF THE INVENTION

Candles are an ubiquitous part of birthday celebrations, being used to provide a festive element and oftentimes representing the age of a person whose birthday is being celebrated. Traditionally, birthday candles are placed directly in a cake or other birthday treat, where they are lit and then blown out prior to consumption of said treat. However, there are some drawbacks to use of birthday candles. One such drawback is that lit candles quickly begin to drip wax. Since candles are commonly placed directly in a cake, as previously referenced, this results in melted wax dripping directly on to the cake. As no one wants to consume wax, this proves to be a hassle.

Currently, there are some ways to avoid the wax issues, though none without their drawbacks. The simplest solution is omitting candles from the birthday cake; this guarantees the cake will be free of wax but also reduces the festivity of a birthday celebration. Alternatively, electronic LED candles could be used, or wax candles could be lit next to the cake rather than being directly placed in the cake. These are better solutions than omitting candles entirely, but are still lacking compared to the traditional method.

A better solution is the provision of candle holders that are placed into the cake. These candle holders catch any melted wax, preventing it from falling onto the cake. However, such candle holders, when removed, may negatively affect the aesthetics of the cake. Further, storage space is required for said holders; having to store candle holders may be troublesome or undesirable, especially when only needed a few times for each year.

It is therefore an object of the present invention to provide an edible birthday candle kit. Candy candles ensure the user or user's kid won't get a mouth full of wax ever again. The edible candy kit may also be consumed, maintaining and even enhancing the aesthetics of a cake while not requiring premium kitchen storage space when not in use.

The present invention includes an emblematic mold that is used to form a substance such as chocolate into a shaped edible. Once the shaped edible is created, a candle holder is positioned onto the shaped edible, while a candle is positioned into the candle holder. The shaped edible is then placed on top of a cake and the candle is lit, wherein the wax is prevented from dripping onto the cake.

### BRIEF DESCRIPTION OF THE DRAWINGS

FIG. 1 is a perspective view of the candle holder being positioned onto the multi-phase edible composition in the solid state; the candle being positioned in the receiving volume of the candle holder.

FIG. 2 is a front sectional view of the shaped edible, wherein the stem is positioned into the multi-phase edible composition being in the solid state.

FIG. 3 is a perspective view of the candle holder, wherein the base and the lateral wall delineate the receiving volume.

FIG. 4 is a perspective view of the emblematic mold, wherein the first body is attached to the second body; the mold casing delineating the mold cavity and the fill channel.

FIG. 5 is a front elevational view, wherein the emblematic mold is filled with the multi-phase edible composition being in the liquid state.

FIG. 6 is a front elevational view, wherein the emblematic mold is filled with the multi-phase edible composition being in the solid state.

FIG. 7 is a perspective view of the emblematic mold, wherein the first hollow is a mirror image of the second hollow.

### DETAIL DESCRIPTIONS OF THE INVENTION

All illustrations of the drawings are for the purpose of describing selected versions of the present invention and are not intended to limit the scope of the present invention.

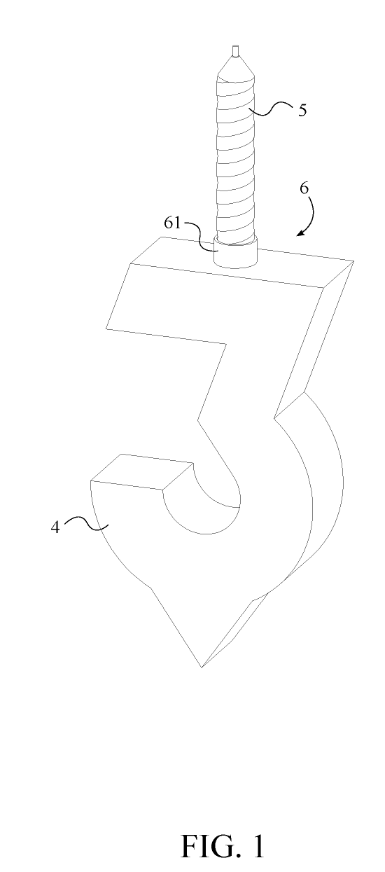

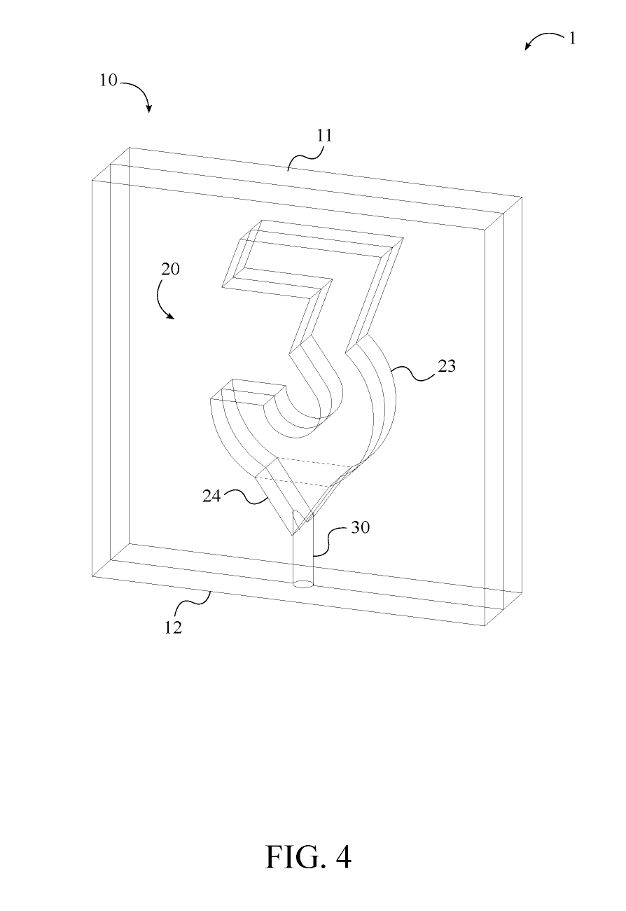

The present invention is an edible candle kit that allows a user to build a custom candy candle. In reference to FIG. 1 and FIG. 4, the edible candle kit comprises an emblematic mold 1, a candle 5, a candle holder 6, and a multi-phase edible composition 4. The emblematic mold 1 is used to shape the multi-phase edible composition 4 into a shaped edible, wherein the shaped edible can then be placed on top of a cake. The candle 5 is then positioned into the candle holder 6, while the candle holder 6 is placed on top of the shaped edible. Such a configuration prevents wax from melting and dripping on the cake, thus protecting the cake. In reference to FIG. 4, the emblematic mold 1 comprises a mold casing 10, a mold cavity 20, and a fill channel 30. The mold casing 10 provides the overall structure of the emblematic mold 1, wherein the mold casing 10 delineates the mold cavity 20 and the fill channel 30. The mold cavity 20 is a hollow recess formed within the mold casing 10, wherein the mold cavity 20 defines the profile of the shaped edible. The fill channel 30 allows the mold cavity 20 to be filled while the mold casing 10 is in a closed configuration. As such, the fill channel 30 is in fluid communication with the mold cavity 20.

The multi-phase edible composition 4 is a product that has a liquid state and a solid state. In the preferred embodiment of the present invention, the multi-phase edible composition 4 is chocolate, however, in other embodiments of the present invention, the multi-phase edible composition 4 may be any other edible material that can be formed into the shaped edible. The multi-phase edible composition 4 is heated in order to transform from the solid state to the liquid state, wherein the mold cavity 20 can be filled with the multi-phase edible composition 4.

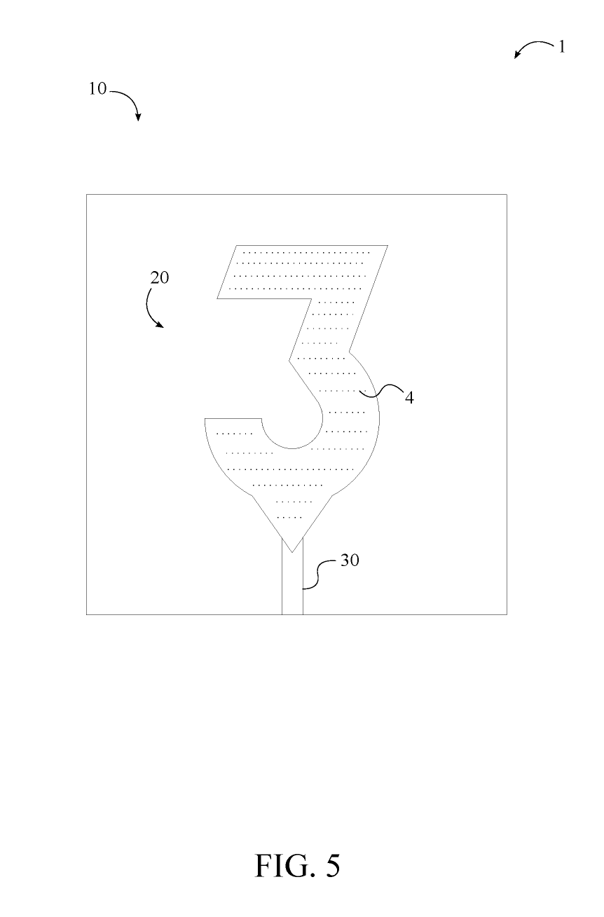

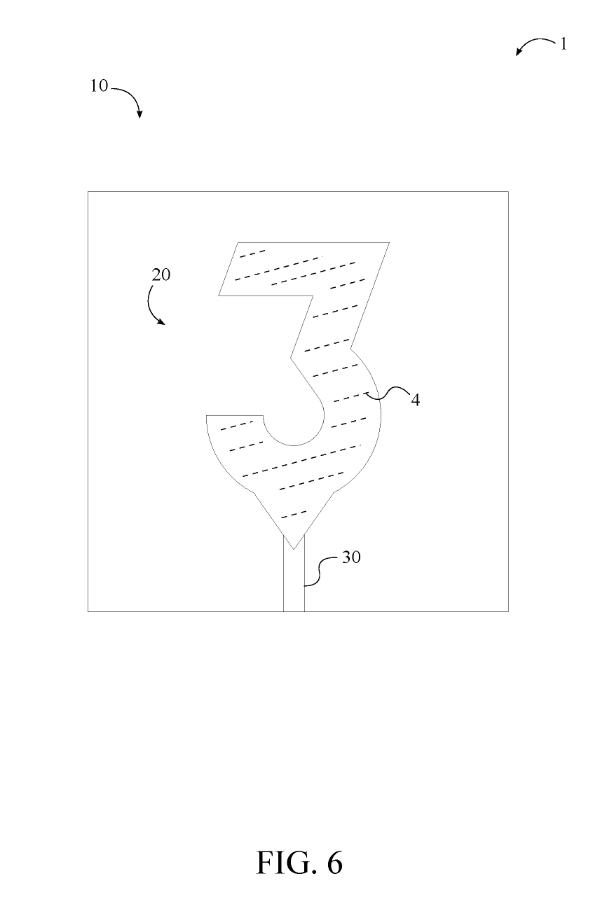

The mold cavity 20 is configured to receive the multi-phase edible composition 4 in the liquid state through the fill channel 30, wherein the fill channel 30 extends from the mold cavity 20 to the perimeter of the mold casing 10. Furthermore, the mold cavity 20 is configured to retain the multi-phase edible composition 4 throughout a phase transition from the liquid state to the solid state, wherein the mold cavity 20 is filled with the multi-phase edible composition 4 in both the liquid state and the solid state as depicted by FIG. 5 and FIG. 6 respectively. The mold casing 10 is configured to provide a tight seal, such that the multi-phase edible composition 4 is not able to leak out of the mold cavity 20 while in the liquid state. In the preferred embodiment of the present invention, the mold cavity 20 is shaped to depict a number, however, other designs and symbols are possible.

In reference to FIG. 4, the mold casing 10 comprises a first body 11 and a second body 12. In order to fill the mold cavity 20 with the multi-phase edible composition 4 in the liquid state, the first body 11 is adjacently attached to the second body 12. When attached together, the first body 11 and the second body 12 form a liquid tight seal, preventing the multi-phase edible composition 4 from leaking out. Once the multi-phase edible composition 4 has cooled and transitioned to the solid state, the first body 11 is detached from the second body 12 and the shaped edible can be removed from the mold cavity 20.

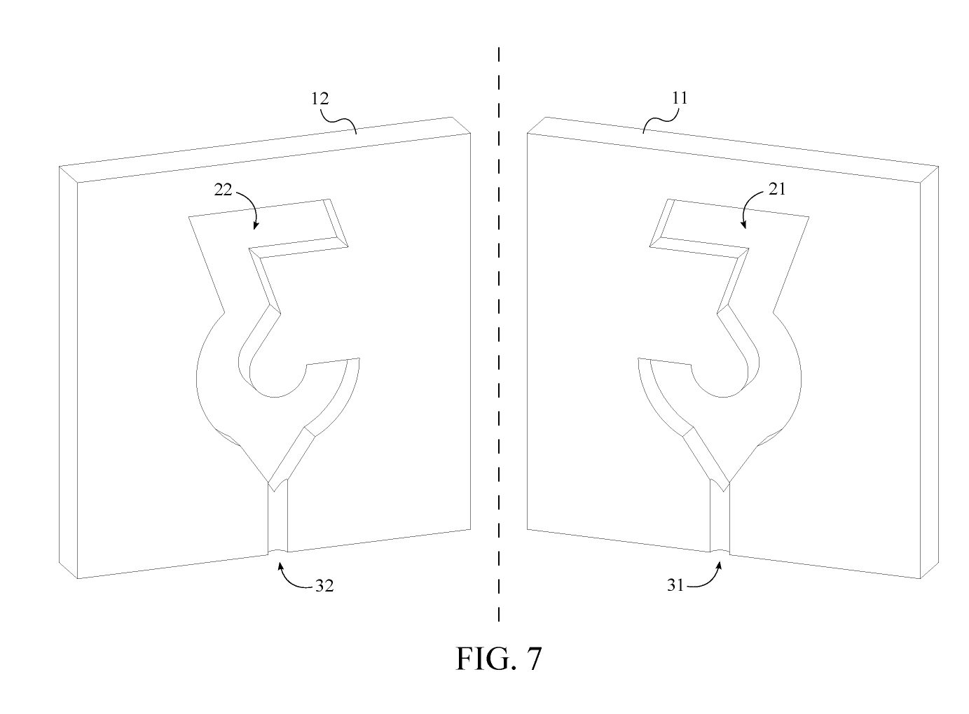

Correspondingly, and in reference to FIG. 7, the mold cavity 20 comprises a first hollow 21 and a second hollow 22, while the fill channel 30 comprises a first slot 31 and a second slot 32. The first hollow 21 and the first slot 31 are delineated by the first body 11, while the second hollow 22 and the second slot 32 are delineated by the second body 12. In the preferred embodiment of the present invention, the second hollow 22 is a mirror image of the first hollow 21. When the first body 11 is attached to the second body 12, the first hollow 21 is aligned with the second hollow 22 and the first slot 31 is aligned with the second slot 32.

In reference to FIG. 4, the mold cavity 20 further comprises a main cavity 23 and a secondary cavity 24; the first hollow 21 and the second hollow 22 delineating the main cavity 23 and the secondary cavity 24 when the first body 11 is attached to the second body 12. The main cavity 23 defines a symbolic structure of the shaped edible, wherein the main cavity 23 is formed to shape the multi-phase edible composition 4 into a symbol, such as a number. Meanwhile, the secondary cavity 24 outlines the shape of a base structure that is to be formed into the shaped edible. The base structure of the shaped edible is designed to securely mount the shaped edible atop a cake. In the preferred embodiment of the present invention, the secondary cavity 24 is wedge shaped, wherein the base structure of the shaped edible is a wedge.

In the preferred embodiment of the present invention, the secondary cavity 24 is positioned in between the main cavity 23 and the fill channel 30. In this way, the multi-phase edible composition 4, being in the liquid state, is poured into the mold cavity 20 through the fill channel 30, wherein the main cavity 23 is first filled with the multi-phase edible composition 4, followed by the secondary cavity 24. In other embodiments of the present invention, the main cavity 23 may be positioned in between the fill channel 30 and the secondary cavity 24.

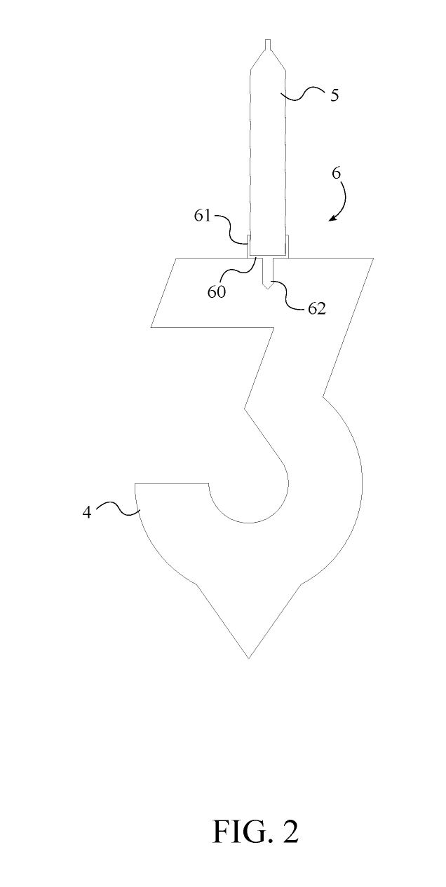

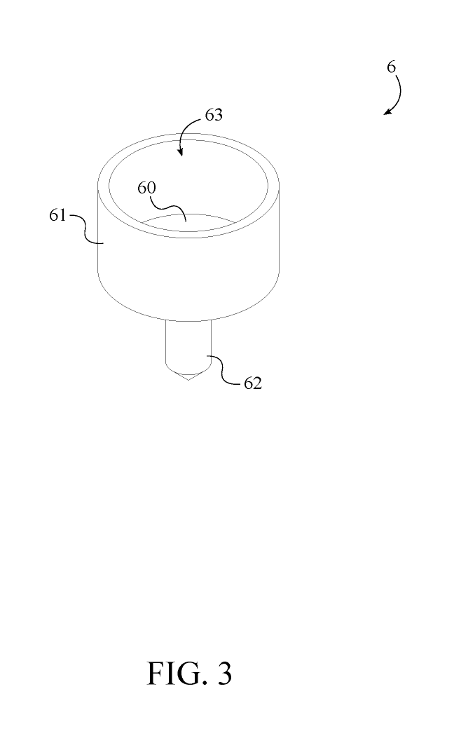

The candle holder 6 is utilized to retain the candle 5 in position atop the multi-phase edible composition 4 as depicted in FIG. 1-2; the multi-phase edible composition 4 being in the solid state. In reference to FIG. 3, the candle holder 6 comprises a base 60, a lateral wall 61, and a stem 62. The lateral wall 61 is perimetrically connected to the base 60, wherein the base 60 is configured to rest on the multi-phase edible composition 4 being in the solid state. Meanwhile, the stem 62 is adjacently connected to the base 60 opposite the lateral wall 61; the stem 62 being configured to be positioned into the multi-phase edible composition 4 being in the solid state.

Together, the base 60 and the lateral wall 61 delineate a receiving volume 63 that is configured to accept and retain the candle 5. The candle 5 is positioned into the receiving volume 63, as depicted in FIG. 1-2, wherein the candle 5 sits on the base 60 and is held in an upright position by the lateral wall 61. The lateral wall 61 has a height that is substantial as to provide adequate support to the candle 5 as the base 60 is positioned on top of the multi-phase edible composition 4; the multi-phase edible composition 4 being in the solid state. As the base 60 is positioned onto the multi-phase edible composition 4, the stem 62 is positioned into the multi-phase edible composition 4 as depicted in FIG. 2, wherein the stem 62 prevents the base 60 from sliding off of the shaped edible.

In order to utilize the present invention, a user first melts the multi-phase edible composition 4 into the liquid state. The user then pours the multi-phase edible composition 4, being in the liquid state, into the mold cavity 20 through the fill channel 30. The emblematic mold 1 is then left to sit at room temperature or in a chilled environment, such that the multi-phase edible composition 4 is cooled and transformed from the liquid state to the solid state. Once the multi-phase edible composition 4 has been cooled to the solid state, the shaped edible can be removed from the mold cavity 20 by separating the first body 11 from the second body 12.

With the shaped edible removed from the mold cavity 20, the candle holder 6 can be positioned onto the multi-phase edible composition 4 being in the solid state; the stem 62 being positioned into the shaped edible and the base 60 resting about the top of the shaped edible. With the candle holder 6 in place, the candle 5 is positioned into the receiving volume 63, wherein the candle 5 is retained in an upright position. The shaped edible is then placed on a cake, wherein the base 60 structure is positioned into the cake to anchor the shaped edible. Meanwhile, the symbolic structure of the shaped edible is displayed in a decorative fashion. The candle 5 is then lit and individuals can sing happy birthday or other celebratory songs, all the while wax is prevented from dripping on the cake.

Although the invention has been explained in relation to its preferred embodiment, it is to be understood that many other possible modifications and variations can be made without departing from the spirit and scope of the invention as hereinafter claimed.

What is claimed is:

1. An edible candle kit comprises:
an emblematic mold;
a candle;
a candle holder;
a multi-phase edible composition, wherein the multi-phase edible composition has a liquid state and a solid state;
the emblematic mold comprises a mold casing, a mold cavity, and a fill channel;
the candle holder comprises a base and a lateral wall;
the mold cavity and the fill channel being delineated by the mold casing;
the mold cavity being in fluid communication with the fill channel;
the mold cavity being configured to receive the multi-phase edible composition in the liquid state through the fill channel;
the mold casing being configured to retain the multi-phase edible composition throughout a phase transition from the liquid state to the solid state;
the lateral wall being perimetrically connected to the base;
the base and the lateral wall delineating a receiving volume;
the base being configured to rest on the multi-phase edible composition in the solid state; and
the candle being positioned into the receiving volume.

2. The edible candle kit as claimed in claim 1 comprises:
the mold casing comprises a first body and a second body; and
the first body being adjacently attached to the second body.

3. The edible candle kit as claimed in claim 2 comprises:
the mold cavity comprises a first hollow and a second hollow;
the first hollow being delineated by the first body; and
the second hollow being delineated by the second body.

4. The edible candy kit as claimed in claim 3, wherein the second hollow is a mirror image of the first hollow.

5. The edible candy kit as claimed in claim 2 comprises:
the fill channel comprises a first slot and a second slot;
the first slot being delineated by the first body; and
the second slot being delineated by the second body.

6. The edible candle kit as claimed in claim 1 comprises:
the mold cavity comprises a main cavity and a secondary cavity; and
the secondary cavity being positioned in between the main cavity and the fill channel.

7. The edible candle kit as claimed in claim 1 comprises:
the mold cavity being filled with the multi-phase edible composition; and
the multi-phase edible composition being in the liquid state.

8. The edible candle kit as claimed in claim 1 comprises:
the mold cavity being filled with the multi-phase edible composition; and
the multi-phase edible composition being in the solid state.

9. The edible candle kit as claimed in claim 1 comprises:
the base being positioned onto the multi-phase edible composition; and
the multi-phase edible composition being in the solid state.

10. The edible candle kit as claimed in claim 9 comprises:
the candle holder further comprises a stem; and
the stem being positioned into the multi-phase edible composition in the solid state.

11. The edible candle kit as claimed in claim 1, wherein the multi-phase edible composition is chocolate.

12. The edible candle kit as claimed in claim 1, wherein the mold cavity depicts a number.

13. The edible candle kit as claimed in claim 1 comprises:
the candle holder further comprises a stem; and
the stem being adjacently connected to the base opposite the lateral wall.
